(19) United States
(12) Patent Application Publication
(10) Pub. No.: US 2017/0120328 A1
(43) Pub. Date: May 4, 2017

(54) DEVICE FOR PRODUCING PELLETS

(71) Applicant: DMG MORI AKTIENGESELLSCHAFT, Bielefeld (DE)

(72) Inventor: Reinhold SEITZ, Hopferau (DE)

(73) Assignee: DMG MORI AKTIENGESELLSCHAFT, Bielefeld (DE)

(21) Appl. No.: 15/344,002

(22) Filed: Nov. 4, 2016

(30) Foreign Application Priority Data
Nov. 4, 2015 (DE) 102015221655.1

(51) Int. Cl. B22F 3/03; B29C 43/00; B29C 43/50; B29C 43/34; B29C 43/40; B29C 31/04; B29C 43/02

(52) U.S. Cl. CPC B22F 3/03; B29C 31/04; B29C 43/006; B29C 43/02; B29C 43/34; B29C 43/40; B29C 43/50; B29C 2043/3427; B29L 2031/772

(57) ABSTRACT

A device produces pellets from pressed material, including a feeding apparatus for receiving pressed material, which is arranged in the region of a feeder screw, a pre-pressing chamber which can be fed by the feeder screw, a closable main pressing chamber having a main ram movable for compacting the content of the main pressing chamber, and an ejecting apparatus having a closing slide, and a cutting device for cutting the pressed material during or after entering the pre-pressing chamber, the device being designed to cut the pressed material supplied to the pre-pressing chamber via the feeder screw so as to provide cut pressed material in the pre-pressing chamber and/or main pressing chamber for the purpose of compaction.

The present invention relates to a device for producing pellets (briquettes) from pressed material. The pressed material is supplied to the system via a feeding hopper, compacted in a pressing chamber and pressed into a pellet. Then, this pellet is ejected. For example, metal or plastic chips are used as pressed material.

### BACKGROUND OF THE INVENTION

Such a device is known from e.g. DE 3038839 A1. A briquette press for briquetting chip fibers or sheet type fine products into briquettes of permanent shape here comprises a reciprocating press plunger and a receiving chamber which is provided with the pressed material from a supply room by a supply device. Directly interconnected hydraulic motors are provided in the drive of the press plunger and of the locking device and are connected to the same pressure source.

An object of the present invention is to provide a generic device for producing pellets so as to obtain a simple, cost-effective and weight-saving device providing improved pressed material compaction. This object is achieved by the features of the independent claim. The dependent claims relate to advantageous embodiments of the invention.

### BRIEF DESCRIPTION OF THE INVENTION

The inventive device for producing pellets from pressed material comprises a feeding apparatus for receiving pressed material, which is preferably arranged in the region of the feeder screw. The device also comprises a pre-pressing chamber which is fed via the feeder screw. A movable main ram can be provided in a closable main pressing chamber to compact the content of the main pressing chamber. The device can also have an ejecting apparatus for pellets and a cutting device for cutting the pressed material. The cutting device can cut the pressed material during or after entering the pre-pressing chamber. Therefore, the device is designed to cut the pressed material supplied via the feeder screw of the pre-pressing chamber by means of the cutting device in such a way that cut pressed material can be provided in the pressing chamber and/or main pressing chamber for the purpose of compaction. In particular, the cut pressed material can be compacted by the main press plunger.

Therefore, it is possible to cut the pressed material prior to the pressing operation and obtain the pellet from the cut pressed material, thus optimizing the pressing operation. In particular, briquettes (pellets) are obtained which have a particularly permanent shape, maximum compaction and simultaneously a highly uniform briquette size. The pressed material can be metallic or consist of a plastic material.

The pre-pressing chamber can be fed via a supply section by the feeder screw, wherein the cutting device can be arranged in the area of the supply section. As a result of this arrangement of the cutting device it is possible to cut the pressed material supplied by the feeder screw directly before or when it enters the pre-pressing chamber so as to achieve a particularly efficient pressed material supply and an improved compaction. It is particularly advantageous to design the cutting device in such a way that shear cutting is possible by providing a cutting plate and a die, each with cut faces. The cut faces are preferably arranged in such a way that they are opposite to one another and form a cutting clearance.

The device can be designed in such a way that the cutting device comprises a cutting press plunger which in the end region can have a cutting section and a pressing section so as to effect joint cutting and pressing of pressed material by the movement of the cutting press plunger in the region of the pre-pressing chamber.

This particularly advantageous arrangement makes it possible to combine the cutting operation and the pre-pressing operation which is preferably carried out in the pre-pressing chamber so as to achieve a very efficient system design. Since the end region has both a cutting section and a pressing section, the cutting operation and the pressing operation can be carried out with the same segment of the cutting press plunger. The presence of a cutting section at the cutting press plunger also guarantees the cutting of the supplied pressed material. For this purpose, the cutting section can preferably have a blade. By using at least one blade it is possible to reduce the imperfect shape of cut pieces (in particular of the pressed material) compared to the mere breaking or tearing and at the same time optimize (reduce) the required force. In a preferred embodiment, the chip angle of the blade is positive, i.e. smaller than 90° in relation to the cutting direction or zero (i.e. 90° in relation to the cutting direction).

The main pressing chamber can be closed by the cutting press plunger. Due to the closing of the main pressing chamber by the cutting press plunger there is the possibility that the pressed material is pre-pressed in the pre-pressing chamber in only one operation and the main pressing chamber is simultaneously closed when e.g. the cutting press plunger reaches a bottom dead center, as a result of which the main press operation can be carried out in the main pressing chamber directly afterwards. The mode of operation of the device is thus further optimized.

The cutting press plunger can have a blade for cutting pressed material in the cutting section. Due to this particularly advantageous embodiment it is possible to cut the supplied pressed material via the cutting press plunger in an efficient and safe way and increase inter alia the quality of the briquette. Due to a corresponding selection of the control of the cutting press plunger, the latter can cut the supplied pressed material once or several times. When the pressed material is cut several times, the quality of the briquette can be further increased for a pre-press operation, thus also improving the density and compactness. On account of a corresponding design of the blade it is also possible to use the most different materials as a pressed material, in particular metal or plastic chips. The blade is preferably hardened.

The cutting press plunger can have a front face with concave curvature. Choosing this curvature for the front face renders it is possible to further improve the cutting operation. In particular, the chip formed in the cutting operation can advantageously be deflected via a concave curvature, thus reducing e.g. a jamming at the lateral faces. Such a jamming occurs e.g. when the chip is not removed from the cutting region in the direct vicinity of the blade after the cutting operation or during the cutting operation, thus producing a material pile-up in the direct region of the blade, which results in jamming. The concave curvature of the front face and thus the concave surface of the cutting press plunger are preferably between the marginal regions where in particular the blade/s is disposed.

The main pressing chamber can be cylindrical, and a concave part of the front face of the cutting press plunger can form part of the cylindrical lateral surface of the main pressing chamber in order to close the main pressing chamber. In other words, the cutting press plunger can retract into and close the press pipe. As a result of this design it is possible to provide the end face of the cutting press plunger with a multi-functional design. Thus, it is possible to ensure, on the one hand, the chip transport required for the cutting operation by the concave curvature of the surface and, on the other hand, a safe closure of the main pressing chamber which has a cylindrical lateral surface. Thus, the concave surface in the end region of the cutting press plunger represents part of the lateral surface of the main pressing chamber. As a result, inter alia the compaction in the pre-pressing chamber is also increased, which improves the quality of the pellet.

The cylindrical lateral surface of the main pressing chamber can have a circular or elliptic base. Such a cylindrical lateral surface having a circular or elliptic base renders possible a simple production of cylindrical pellets and/or briquettes, which in particular in comparison with pellets with an edged or rectangular shape, i.e. also with the shape of a cuboid, have the advantage that the lateral area does not contain any longitudinal edges where only a poor compaction can be achieved. Due to a circular base it is thus possible to increase the compaction of the pressed material and improve the quality of the pellet. In addition, this facilitates an ejection.

The main pressing chamber can be made as a cavity of a pipe. Therefore, a pipe can comprise the main pressing chamber and this pipe can be inserted into the device. As a result, it is possible to easily exchange the main pressing chamber in the device according to the invention by simply exchanging the pipe. Furthermore, there is a possibility of varying the diameter of the pellet to be produced by correspondingly selecting the inner diameter and outer diameter of the pipe. A variation in the pellet diameter can thus be achieved with the device when the pipe is adapted appropriately to the associated main pressing chamber and in particular when the inner diameter of the pipe is adapted.

The device can have an intermediate plate in the region of the main pressing chamber. This intermediate plate can have a discharge opening for discharging liquid from the main pressing chamber. In addition, the device can have a trough for receiving the liquid. In particular in the case of metal chips there are often oil residues and other liquid residues on the chips, as a result of which these liquids are pressed out of the chips by the pressing operation. In order to improve the compaction of the briquette, a discharging opening for discharging liquids is thus provided to allow the liquids to leave the main pressing chamber and to improve compaction.

The discharge opening can be made as an annular gap which borders on the main pressing chamber and preferably also on the ejecting apparatus. Due to the provision of an annular gap as a discharge opening it is possible to uniformly receive and remove the pressed-out liquid. Therefore, such an annular gap is arranged in particular in the region of the circumference of the main pressing chamber along the circumference. The gap preferably has an opening having a width of 0.5 mm to 2 mm and extending along the circumference.

The main pressing chamber can have a discharge opening for discharging the liquid pressed out of the pressed material. As a result, the press quality can be increased in a simple way without additional components.

The feeding apparatus can comprise a feeding hopper, it being possible to provide a preferably extendible additional apparatus at the feeding hopper in order to increase the safety.

The device can have a cutting plate with a cutting edge in the supply section, wherein the cutting plate can be made in particular as a cutting ring. Therefore, in order to increase the cutting quality, the cutting press plunger can be provided with a blade and, as a counterpart thereto, a cutting plate having a blade. As a result of the cooperation of these two blades which are associated with one another, an extremely efficient cutting operation is ensured. The formation of the cutting plate as a cutting ring is particularly advantageous. Here, the cutting ring can have a blade extending along the circumference (radially), as a result of which pressed material passing through the cutting ring can be cut in an extremely efficient manner.

The cutting press plunger can be arranged so as to be translationally moveable. As a result of the movement of the cutting press plunger with the blade in relation to the cutting plate it is possible to cut pressed material. Therefore, the pressed material supplied through the supply section is cut at the blade of the cutting plate in cooperation with the blade of the cutting board press plunger.

The main ram can have a main press plunger which can have a cambered end face. Due to this design, the structural stability of the main press plunger is increased, on the one hand, and the compaction of the pressed material is improved, on the other hand.

The device can have an ejecting apparatus and a closing slide. The ejecting apparatus can have an intermediate piece having an opening, wherein the opening can be arranged in such a way that pressed material can be moved through the opening and the opening can have a funnel-type design.

In order to drain liquids into a container, the trough can have a funnel-shaped inclined bottom. It is thus possible to easily collect the pressed-out liquid in a container without requiring a pump.

A machine tool can be equipped with a device as described above. As a result, the efficiency of the machine tool can be increased in a special way since after each machining operation of the machine tool the accumulated chips can be further processed directly into briquettes by means of the pressing operation of the above mentioned device. Furthermore, accumulating liquid, such as oil, lubricant or cooling liquid, can be returned to the machine tool via the device.

The device for producing pellets can also be made as a plug and play solution in the form of an independent unit having a preferred control variable of no more than 1 m². Therefore, this device can easily be connected to various machines.

Advantageous embodiments and further details of the present invention are described below by means of various embodiments with reference to schematic drawings. The invention is explained in more detail in the schematic drawings.

### BRIEF DESCRIPTION OF THE DRAWINGS

FIG. 1 shows the section H-H of an embodiment of the device according to the invention for producing pellets from pressed material;

FIG. 2 shows an enlarged view of the section H-H;

FIG. 3 shows the section J-J of the embodiment according to the invention;

FIG. 4b shows a longitudinal section through the central receiving member;

FIG. 4c shows a side view of the central receiving member;

FIG. 4d shows the section B-B through the central receiving member;

FIG. 4e shows the section C-C through the central receiving member;

FIG. 4f shows the section D-D through the central receiving member;

FIG. 5a shows a first view of the cutting press plunger;

FIG. 5b shows a sectional view of the cutting press plunger;

FIG. 5c shows a side view of the cutting press plunger;

FIG. 6a shows a first view of the press pipe;

FIG. 6b shows a view of the press pipe;

FIG. 6c shows a side view of the press pipe;

FIG. 7a shows a first view of the closing slide;

FIG. 7b shows a side view of the closing slide;

FIG. 7c shows a sectional view through the closing slide;

FIG. 7d shows a front view of the closing slide;

FIG. 8a shows a first view of the cutting ring;

FIG. 8b shows a front view of the cutting ring;

FIG. 8c shows a sectional view of the cutting ring;

FIG. 9a shows a first view of the main press plunger;

FIG. 9b shows a front view of the main press plunger;

FIG. 9c shows a sectional view of the main press plunger;

FIG. 10a shows a first view of the intermediate plate;

FIG. 10b shows a front view of the intermediate plate;

FIG. 10c shows a rear view of the intermediate plate;

FIG. 10d shows a sectional view of the intermediate plate;

FIG. 11a shows a first view of the ejector;

FIG. 11b shows a second view of the ejector;

FIG. 12a shows a first view of the threaded pin;

FIG. 12b shows a second view of the threaded pin;

FIG. 13a shows a first view of the guide;

FIG. 13b shows a second view of the guide;

FIG. 13c shows a sectional view of the guide.

### DETAILED DESCRIPTION OF THE DRAWINGS AND EMBODIMENTS OF THE INVENTION

Various examples of the present invention are described in detail below with reference to the drawings. Equal or similar elements in the drawings are designated with equal reference signs. However, the present invention is not limited to the described features but also comprises modifications of features of the described examples and combinations of features of various examples on the basis of the scope of the independent claims.

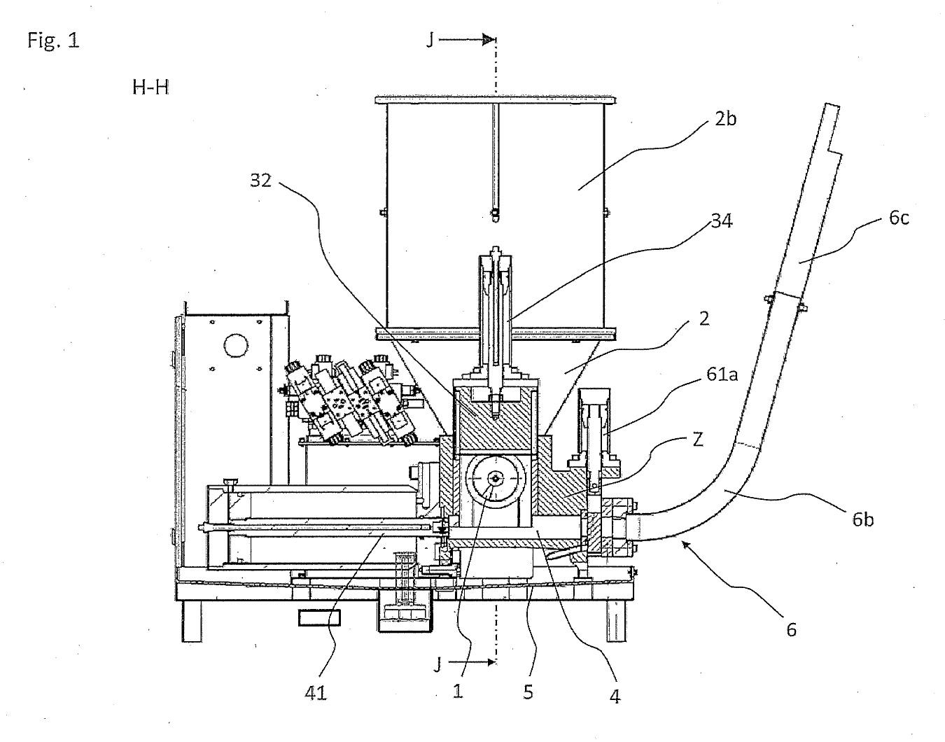

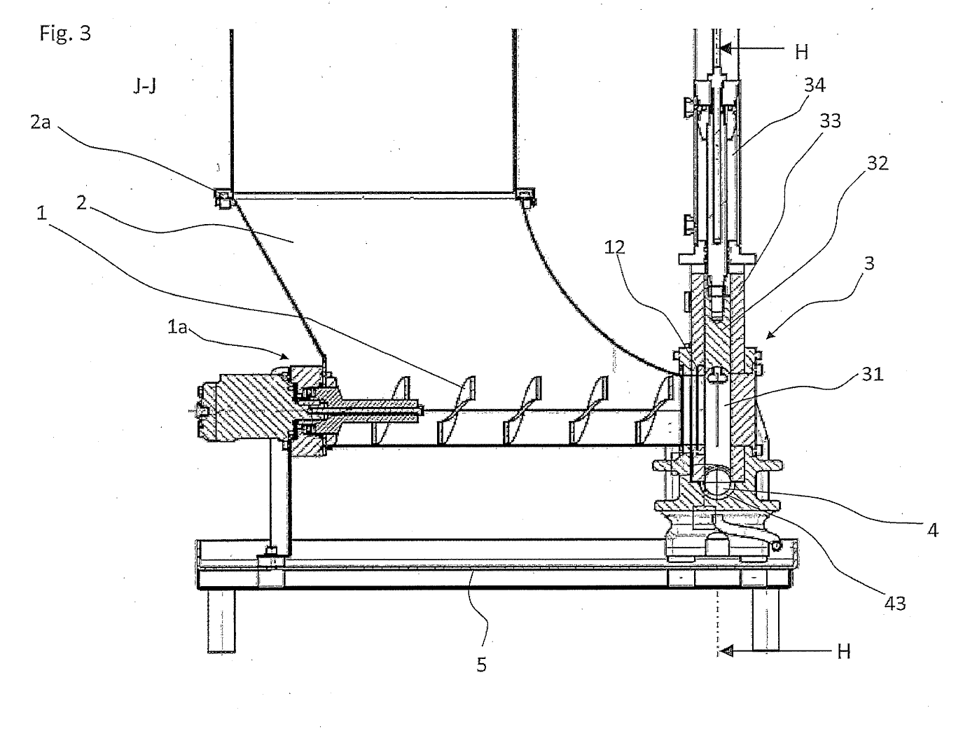

FIG. 1 shows a sectional view H-H of the device for producing pellets/briquettes (the course of section H-H follows from FIG. 3). The device shown is preferably used for processing pressed material such as metallic chips or chips made from plastic material. The device shown (briquette press) is designed in a particularly advantageous manner as part of a machine tool. The chips accumulating due to the work processes of the machine tool can thus be further processed into briquettes in the same machine tool in highly efficient manner, and the accumulating liquid, such as lubricant or cooling liquid, can simultaneously be returned directly into the machine tool. The device can advantageously be designed in such a way that by providing the pedestals e.g. with wheels and connecting pieces for machine tools said device can be connected to various machine tools and is mobile. The special advantage is that the device can be used for various machine tools and/or machines and thus, depending on the just operated machine, can be connected thereto. Therefore, an extremely flexible and efficiently usable system is provided by such a mobile and flexibly connectable device for producing briquettes.

In the sectional view in FIG. 1, the supplied chips (or generally pressed material) are filled into the feeding hopper 2 via the adapter 2b. An end portion of the feeding hopper 2 comprises a feeder screw 1, via which the pressed material is conveyed for the further work steps. The feeding hopper 2 is connected to the adapter 2b via a screw connection 2a. The feeding hopper has inclined lateral surfaces, via which the pressed material supplied to the screw and/or to the supply region is deflected in the region of the pre-pressing chamber 31. The feeder screw 1 (conveyor screw) is mounted on one side on the mounting 1a and driven via the drive 1b. The speed of the screw can be adapted depending on the supplied pressed material and further processing parameters (in particular also the size of the cutting clearance,). The feeder screw 1 comprises a screw shaft and a screw thread. In a development of the present invention, the screw thread is tapered at the end faces of the flanks, as a result of which cutting of the supplied pressed material can already be achieved by rotating the supply screw with a preferred adjustable cutting clearance in between.

The supplied pressed material, which meets with the feeder screw 1 via the feeding hopper, is conveyed via this feeder screw, preferably continuously via a supply section into the pre-pressing chamber 31. A cutting ring 12 (cutting plate) can be arranged in this supply section. The cutting ring 12 has an opening through which the pressed material is conveyed. A preferably fully circumferential blade is arranged on the side of the opening of the cutting ring 12 that faces the cutting press plunger 32. The cutting press plunger 32 also has preferably a blade which can border directly on the blade of the cutting ring. Thus, when pressed material is conveyed into the pre-pressing chamber 31 or the main pressing chamber 4 via the supply section by the feeder screw 1, it can be cut by means of moving the cutting press plunger by the blade of the cutting ring 12. It is here possible in the production of a briquette to move the cutting press plunger 32 several times so as to cut the pressed material for this briquette several times and/or it is possible to move the cutting press plunger 32 only once to cut the supplied pressed material which has not yet fully entered the pre-pressing chamber 31. Therefore, the supplied pressed material is cut via the cutting device 3.

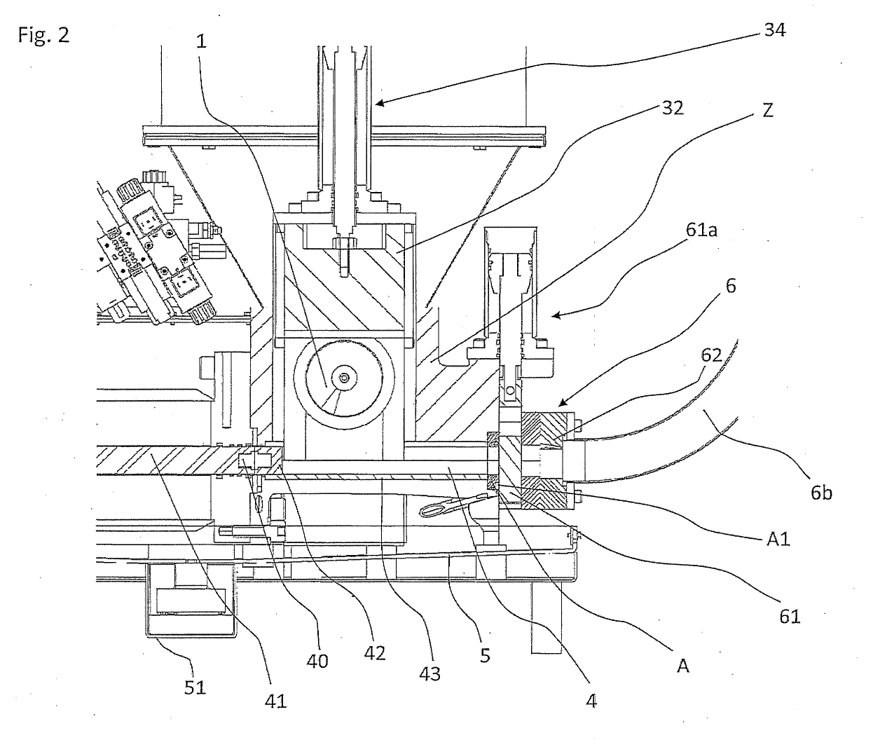

The cutting device 3 comprises a cutting press plunger 32, which is movably guided in the plunger guide 33. On a lower side in the end section, the plunger guide 33 borders on the main pressing chamber 4 and forms the prepressing chamber 31 between the main pressing chamber and the supply section. The pre-pressing chamber 31 serves to pre-compact the supplied pressed material before it is compacted into a pellet (briquette) in the main pressing chamber in the main processing operation. The cutting press plunger 32 is actuated via a pre-pressing hydraulic system 34. However, the pre-pressing hydraulic system 34 can also be replaced with another drive which renders possible to move the cutting press plunger 32 with increased frequency so as to carry out several cutting operations in a short time. In particular, such a reciprocating movement of the cutting press plunger 22 can be achieved via a transmission and an electric motor. The front face of the cutting press plunger 32 has a concave surface which serves, on the one hand, to remove chips and, on the other hand, to close the main pressing chamber 4. Therefore, this front face of the cutting press plunger 32 forms part of the lateral surface of the cylindrical main pressing chamber 4, as a result of which the cutting press plunger 32 closes the main pressing chamber 4 in a lower position (preferably in the bottom dead center), and the main pressing operation can be carried out directly after closing the main pressing chamber 4. The main pressing chamber 4 is provided as an interior of a press pipe 43. The oil or the liquids pressed out during the main press operation are discharged via a discharge into a trough 5 to be collected in a collecting container. When the device is connected to a machine tool, the collected liquid can be returned to the machine tool so as to reduce e.g. the cooling emulsion consumption. FIG. 1 additionally shows the course of the section from H to H, which is specified in FIG. 2.

Section H-H shown in FIG. 2 shows an enlarged sectional view of the briquette press. The pressed material is filled into the pre-pressing chamber via a feeder screw 1, the cutting press plunger 32 shown in the upper position (in the top dead center) performing a translational movement in the direction of the main pressing chamber 4 via the pre-pressing hydraulic system 34. When this movement is performed, the supplied pressed material is cut, on the one hand, and the supplied pressed material is simultaneously pre-compacted in the pre-pressing chamber 31, on the other hand. As regards the main pressing operation, the pre-pressed pressed material is actuated via a main ram by a main pressing hydraulic system 42 and compacted in the main pressing chamber in the direction of the ejecting device 6. In order to receive the guide of the cutting press plunger and the press pipe and to connect the ejecting apparatus 6, a central receiving part Z (central piece) is provided. The liquid pressed out in the main pressing operation is conveyed into the trough 5 via a discharge opening, said trough having an inclined bottom surface, as a result of which the pressed-out liquid can collect in a container. Having reached the final compaction, the pellet is ejected via an ejecting apparatus 6. For this purpose, the opening hydraulic system 61a is activated, as a result of which the pellet is released and ejected via the ejecting apparatus 6 along the arch piece of the ejector 6b and of the tangent piece of the ejector 6c.

FIG. 3 shows the section J-J. The course of section J-J follows from FIG. 1. The cutting press plunger 32 is connected to the hydraulic ram of the pre-pressing hydraulic system 34 via a threaded hole so as to carry out the necessary reciprocating movement or up-and-down movement. In the bottom dead center, the cutting press plunger 32 preferably closes the press pipe 43. Therefore, the press pipe 43 has a lateral opening which can be closed by the cutting press plunger 32 by means of the concave surface.

The main press plunger 42 is inserted in the region of the first end of the press pipe 43 in the longitudinal direction and can be moved within the press pipe 43 in the longitudinal direction. The main press plunger 42 is connected to the main ram 41 of the main press hydraulic system via a connecting element 40. When the main ram 41 is actuated via the control apparatus, the main press plunger is returned translationally in the direction of the ejecting apparatus 6.

When the cutting press plunger has pressed the cut and pre-pressed pressed material in the main pressing chamber to close the latter, the pressed material is compacted into the pellet by a corresponding control of the main ram via the main press plunger 42. The main press plunger 42 moves translationally in the direction of the closing slide 61 which as a counterpart to the main press plunger 42 receives the pressing forces in the longitudinal direction along the press pipe 43. In the end region of the main pressing chamber, 4 and bordering on the closing slide 61, a discharge opening A1 is provided in an intermediate plate A. It is possible via this discharge opening A1, which preferably borders directly on the closing slide 61, to discharge the liquid resulting in the main pressing chamber by compacting the pressed material out of the main pressing chamber 4. Due to this, the compaction of the pressed material can be increased and thus a particularly compact pellet is obtained. The pressed-out liquid is conveyed via an outlet channel in the trough 5 via which it can flow into the collecting container 51.

Having reached the end form or the desired pressing state of the pellet, the closing slide 61 is moved downwards via the opening hydraulic system 61a to unblock the ejecting channel. Having unblocked the ejecting opening, the pellet can be further pressed out into the ejection channel via the main press plunger 42, the pellet passing an ejector plate 62 during this ejecting operation. In the further course, the pellet is then passed on via the arch piece 6b.

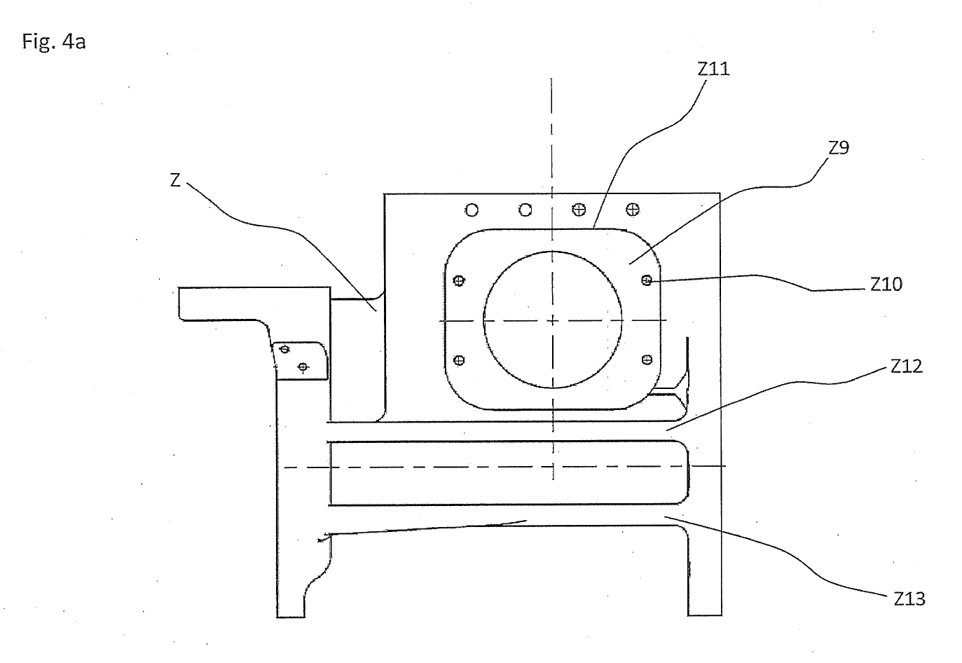

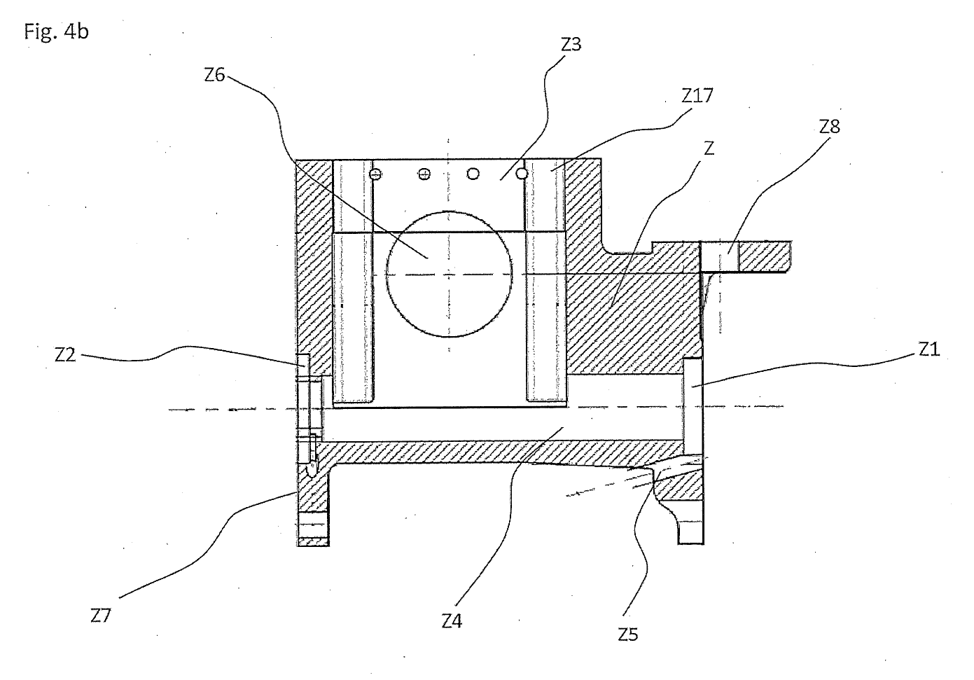

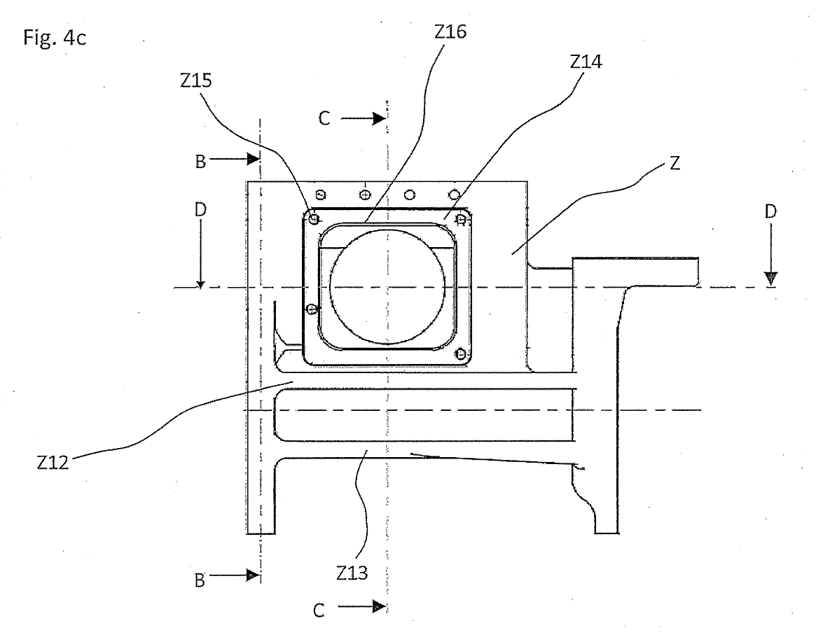

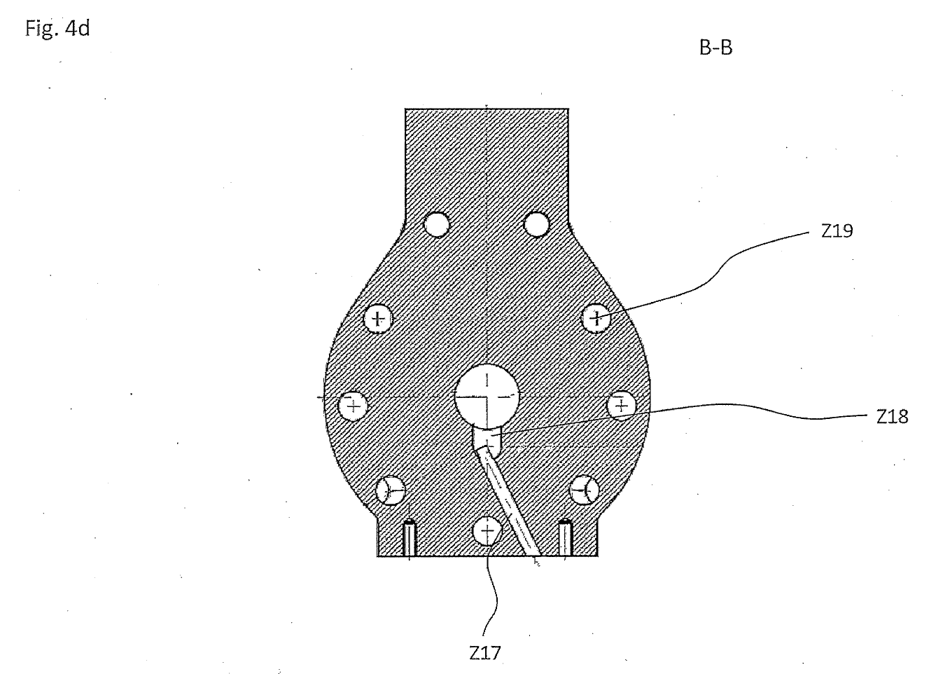

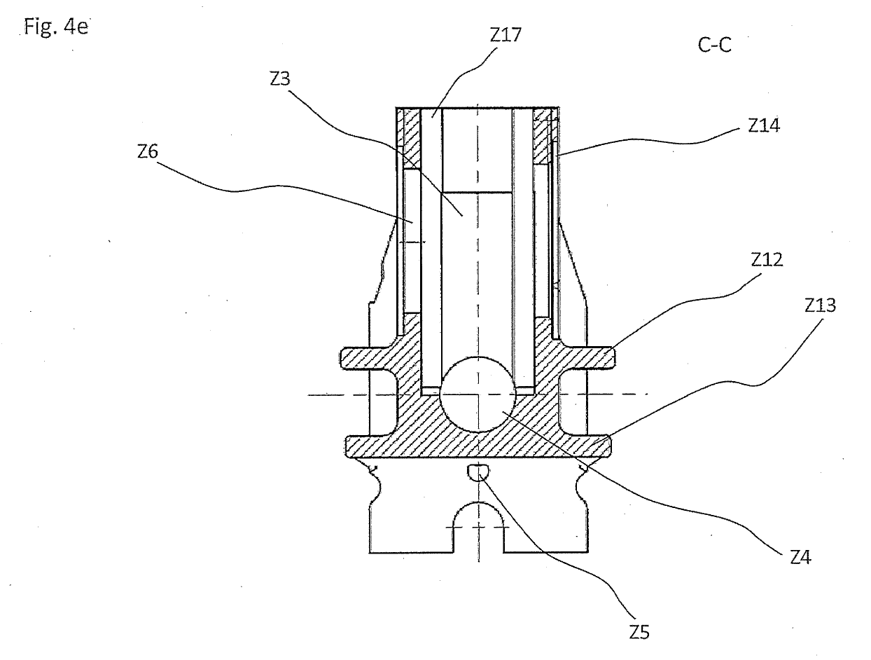

FIG. 4a shows a first view of the central receiving part Z. The illustrated view shows a connecting surface Z9, via which the screw or the feeding hopper 2 can be connected to the central receiving part Z. For this purpose, the attachment holes Z10 are shown which are uniformly distributed over the connecting surface Z9. The connecting contour Z11 corresponds to a rectangle having rounded corners. In order to increase the rigidity of the central receiving part Z, an upper rib Z12 and a lower rib Z13 are arranged laterally on the central receiving part. Such a rib arrangement is found on both sides of the receiving part.

FIG. 4b shows a first sectional view of the central receiving part Z. The guide of the cutting press plunger is provided in the central receiving part Z via the guide support Z17. Furthermore, the central receiving part Z has a supply opening Z6, via which the pressed material is supplied to the pre-pressing chamber. The surface where the supply opening Z6 is arranged corresponds to the lateral surface of the guide support Z3. The press pipe support Z4 is arranged in the lower section of the central receiving part Z. The respective press pipe 43 is inserted into the press pipe support Z4. The diameter of the resulting pellets can be adjusted by varying the inner diameter of the press pipe.

Furthermore, the surface finish of the pellets can be improved by correspondingly selecting the material of the press pipe. The inner surface of the press pipe is preferably hardened. In an end region of the press pipe support Z4, the central receiving part Z has a stop for the press pipe to be inserted. Via the stop it is possible to insert the press pipe on one side until it reaches the stop so as to easily adjust the optimum longitudinal position of the press pipe. Furthermore, the main plunger press support Z2 is also provided at this stop and the main press plunger is inserted into the press pipe via this support. The central receiving pipe Z is connected to the main press hydraulic system or the main press device via the main press device connection Z7. An intermediate plate support Z1 is provided at the opposite end of the stop of the press pipe support Z4 and an intermediate plate can be inserted into this intermediate plate support which borders on a discharge channel Z5 for discharging the pressed-out liquid.

FIG. 4c shows a side view of the central receiving part Z. This side of the central receiving part Z preferably contains a cover which can be used for inspections and overhauls or also repairs of the pre-pressing chamber and the adjoining regions (preferably also to exchange the cutting plate). Furthermore, the central receiving part Z has a revision cover opening 16 (inspection opening) and a receiving surface Z14 for the cover. The cover is connected or screwed to the central receiving part Z via the cover attachment Z15. This side of the central receiving part Z also accommodates the upper rib Z12 and the lower rib Z13 in order to increase the strength of the central receiving part Z. In addition, FIG. 4c shows the courses of sections B-B and C-C.

FIG. 4d shows the section B-B through the central receiving part Z. The central opening in FIG. 4d is limited by the main plunger press support Z2, which has a collecting section Z18 in the lower region and which opens into a discharge Z17. Excess liquids from the region of the main plunger press support Z2 can be discharged via these openings. In order to attach the main pressing device and the associated main pressing device connection flange Z7, the flange bores Z19 are provided which are arranged at a respectively equal distance from the main press plunger support Z2 and have an angle of at least 15° in relation to one another.

FIG. 4e shows another sectional view of the central receiving part Z, namely section C-C. Opposite thereto in front of the opening Z6, through which the supplied pressed material is inserted into the pre-pressing chamber, the region of the overhaul cover is arranged which is attached to the central piece via the receiving surface Z14. In order to receive the cutting press plunger, a guide is provided in the central piece via the guide support Z17 and the lateral surface of the guide support Z3. The lower region of the guide support shows the press pipe support Z4. In order to increase the rigidity of the central piece, an upper rib Z12 and a lower rib Z13 are provided on both sides in the region of the press pipe support Z4.

FIG. 4f shows the sectional view of D-D of the central piece. Here, the tapering course of the upper rib Z12, which tapers from the connecting region of the main press device to the connection region of the ejecting apparatus, is well seen. FIG. 4f in turn shows the overhaul cover opening Z16 and the connecting surface Z9 in the supply region for the pressed material. In addition, the guide support Z14 and the lateral surfaces of the guide support Z3 are shown. The course of the pre-pressing chamber and/or the base of the pre-pressing chamber are shown in FIG. 4f as a rectangle. Therefore, the pressed material is moved via the circular supply opening by the feeder screw 1 via the supply region through the guide through a circular opening into the rectangular pre-pressing chamber.

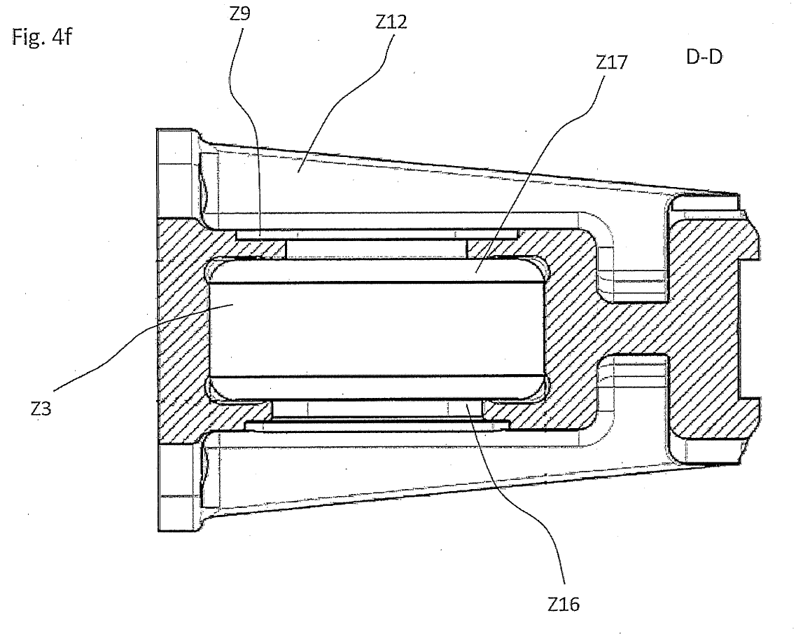

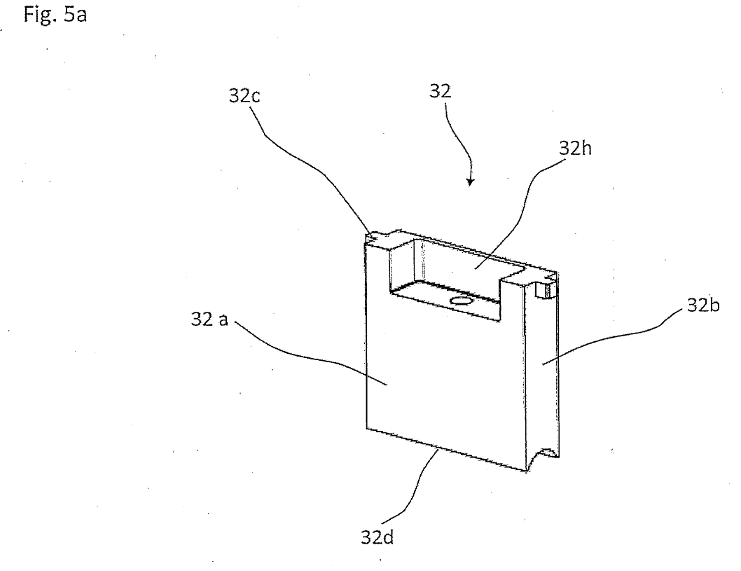

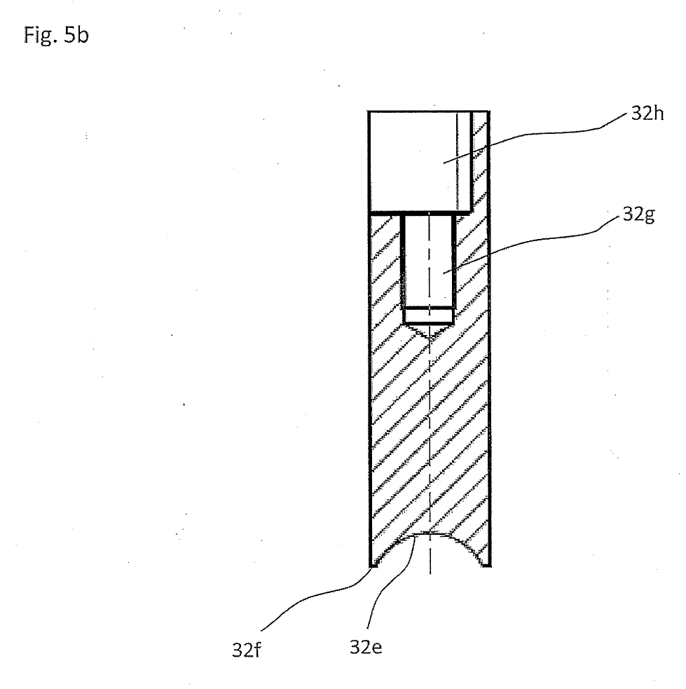

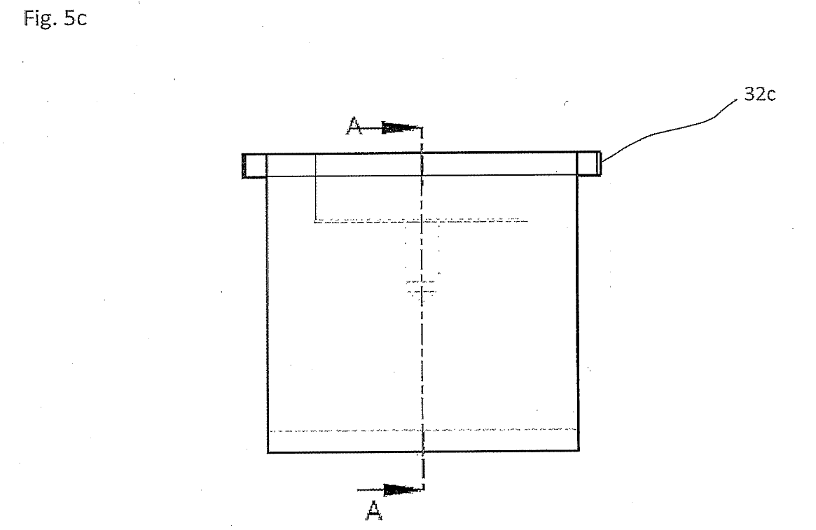

The cutting press plunger 32 having a cutting region and pressing region arranged on the lower side thereof is shown in FIG. 5a. The cutting region and pressing region of the plunger are arranged on the operating side 32d of the cutting press plunger 32. The cutting press plunger 32 has two main surfaces 32a and two lateral surfaces 32b, which enclose the body of the cutting press plunger 32. In order to safely guide the cutting press plunger 32, the latter has two guide elements 32c, which are arranged on the upper side of the cutting press plunger 32. In the illustrated embodiment, the guide elements 32c are made as cubic elements protruding from the lateral surface 32b.

FIG. 5b shows a sectional view of the cutting press plunger 32. The free cut 32h is disposed on the upper side of the cutting press plunger 32 and serves in connection with the attachment bore 32g to attach the cutting press plunger to the respective actuator of the plunger. On the lower side or working side 32d of the cutting press plunger 32, an edge 32f (blade) is shown which opens into a concave front face (or curved operating surface) 32e. The concave front face 32e runs along the edge 32f of the main surface 32a and thus along the longitudinal direction of the rectangular base of the cutting press plunger 32. It is particularly preferred for the lower side, in particular the operating side 32d of the cutting press plunger, to be additionally hardened. The curvature of the concave front face extends preferably along a main axis of the cutting press plunger 32, which is preferably orthogonal to the movement direction of the cutting press plunger 32. The edge 32f of the cutting press plunger (or blade) extends, in the illustrated example, orthogonal to the moving direction of the cutting press plunger which moves along the axis that is parallel to the height of the body of the cutting press plunger 32. In a further embodiment, the edge 32f is not provided as a continuous edge between the lateral surfaces 32b but has one or more regions with equal or different pitches so as to achieve a serrated contour of the edge. In a further embodiment, the edge 32f extending in FIG. 5b orthogonally to the moving direction along the stroke axis of the cutting press plunger 32 has a work angle with respect to this movement axis. This work angle is preferably in a range of 2° to 30° and preferably 27°. By means of such an angle it is possible to form an inclined edge in such a way that the cutting operation can be further improved by the cutting press plunger 32. In other words, the edge 32f has an angle which is not equal to 90° with respect to the lateral surface 32b (or also the plunger movement direction) in this special development, and therefore the edge 32f is no longer orthogonal to the lateral surface 32b (or also to the plunger movement direction). FIG. 5c also shows a lateral view of the cutting press plunger 32 with the laterally attached guide elements 32c.

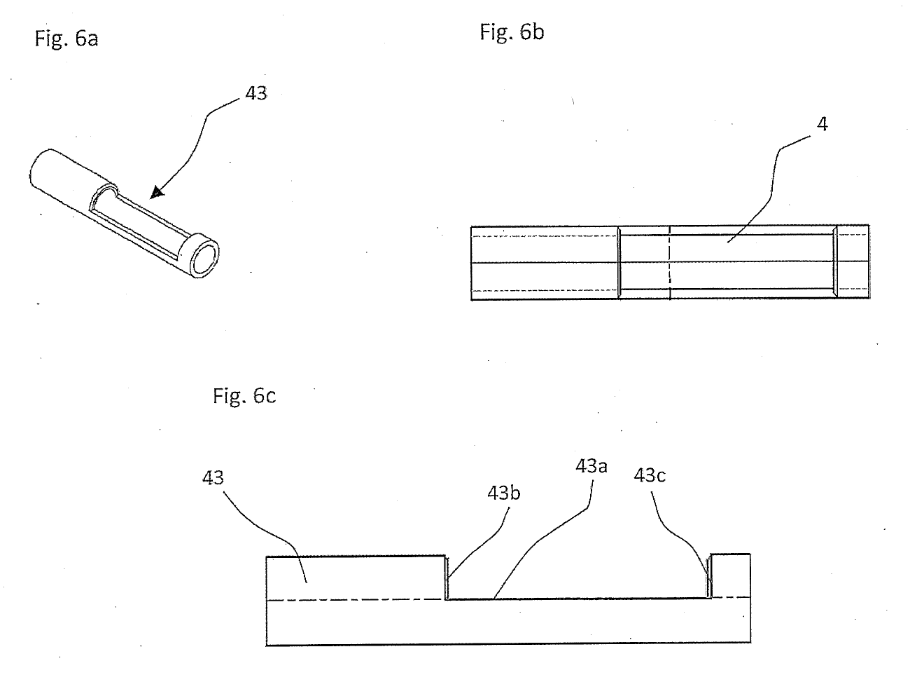

The press pipe 43 is preferably open on both sides and has a free cut in the lateral surface, as shown in FIG. 6a. The free cut of the press pipe 43 preferably extends from the outer circumference in a radial direction up to the longitudinal axis of the press pipe 43. The free cut extends between the end regions of the press pipe 43 in an axial direction but without reaching an end of the pipe. The main pressing chamber 4, as shown in FIG. 6b, is formed by the inner space of the press room 43.

The press pipe free cut according to FIG. 6c is limited by a first lateral surface 43b and a second lateral surface 43c in an axial direction, a lower limitation 43a of the press pipe free cut being available in a radial direction. The lower limitation 43a of the press pipe free cut is preferably formed along the central line or along the longitudinal axis of the press pipe 43. In the free-cut section of the press pipe 43, up to half of the press pipe is thus free-cut in a radial direction such that the remaining part of the press pipe 43 forms a semi-circle in the region of the press pipe free cut. In order to close the main pressing chamber 4, the press pipe free cut is closed with the cutting press plunger. Therefore, as a concave front face 32e the cutting press plunger preferably has a front face with a curvature which corresponds to a semi-circle having a radius r of the inner circle of the base of the press pipe 43. When the cutting press plunger is joined with the press pipe 43, a continuous inner space is formed which is cylindrical and has a circular base and the radius r. In order to improve the engagement of the press pipe 43 with the cutting press plunger, the first lateral surface 43b and the second lateral surface 43c of the press pipe 43 have a chamfer which facilitates the engagement of the cutting press plunger.

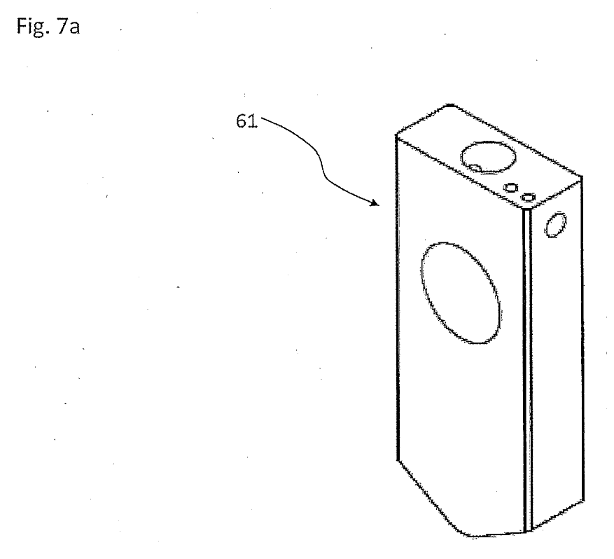

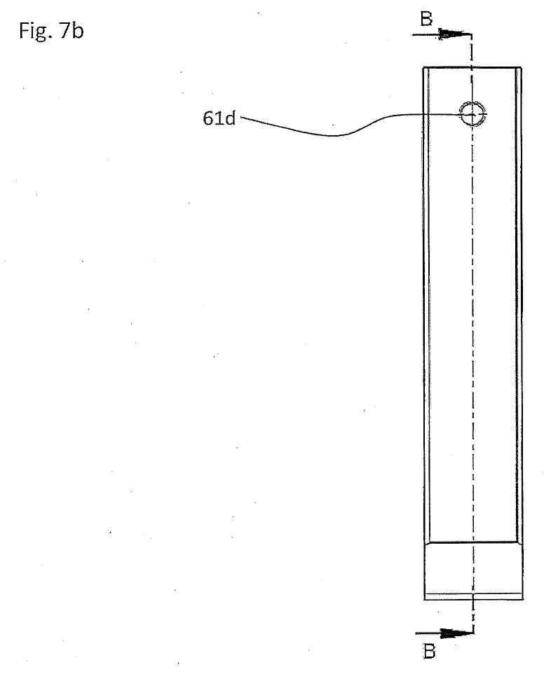

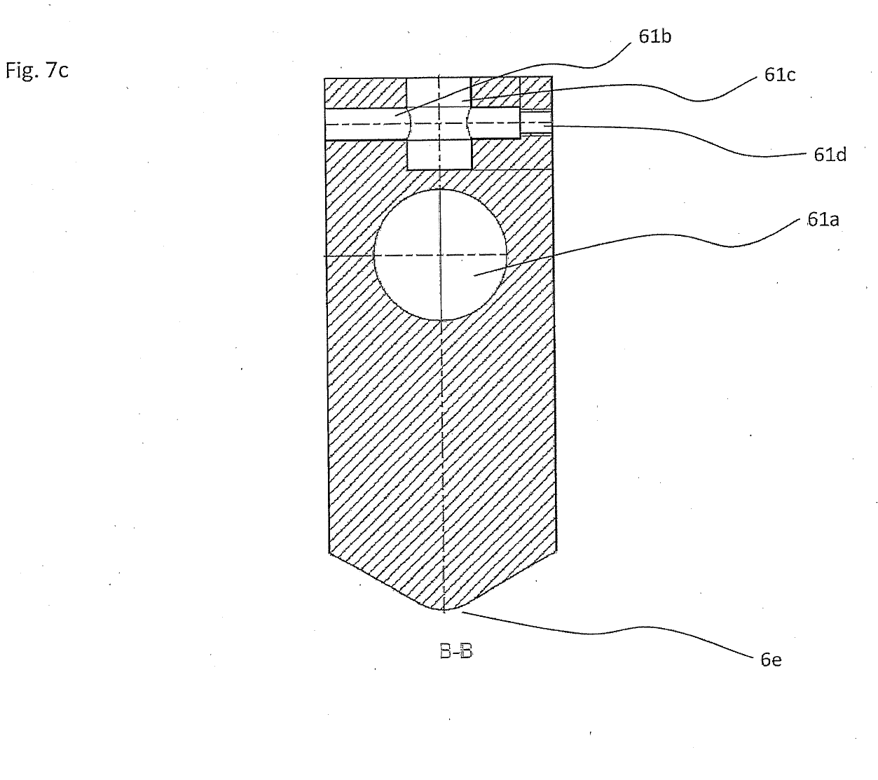

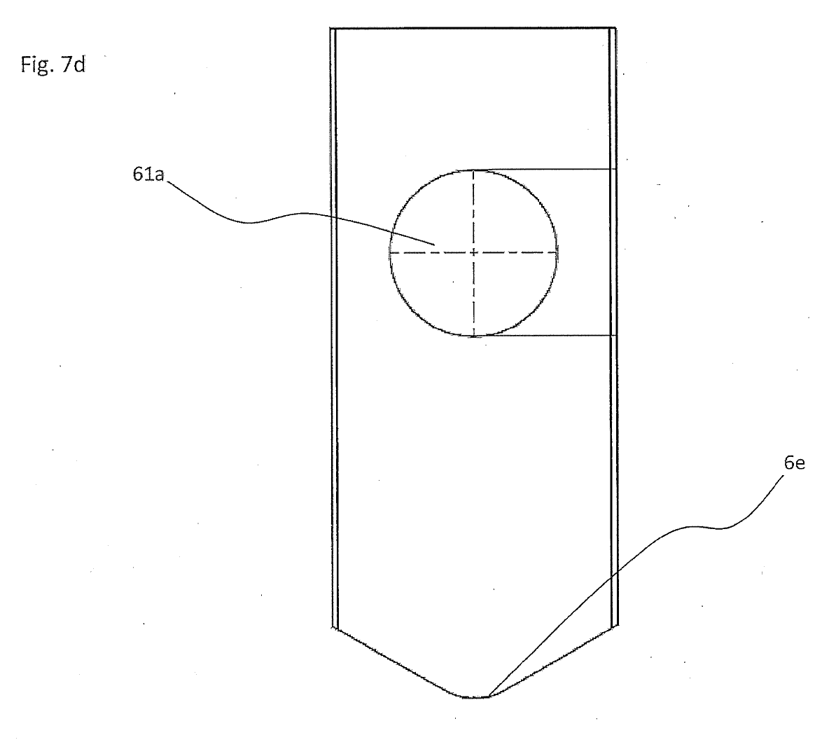

The closing slide 61 is shown in FIG. 7a. It has a tapering front side 6e which has a rounding in the end region. The finished briquette is conveyed into the ejecting apparatus 6 via the through opening 61a of the closing slide 61. The main surface of the closing slide 61 serves as a counterpart to the main press plunger 42 during the pressing operation. Therefore, the pressed material is pressed by the main pressing plunger 42 against the main surface of the closing slide 61. In order to connect the closing slide to the opening hydraulic system 61a, the closing slide 61 has a through opening 61b, an engagement opening 61c and an attachment thread 61d. The direct connecting piece is attached to the press body of the opening hydraulic system 61a via the engagement opening 61c, namely by inserting a pin into the through opening 61b, which is preferably screw-connected via an attachment thread 61d. These openings are also shown in FIG. 7c, the attachment thread 61d being also shown in FIG. 7b. FIG. 7d shows the through opening 61a and the front side 6e of the closing slide 61.

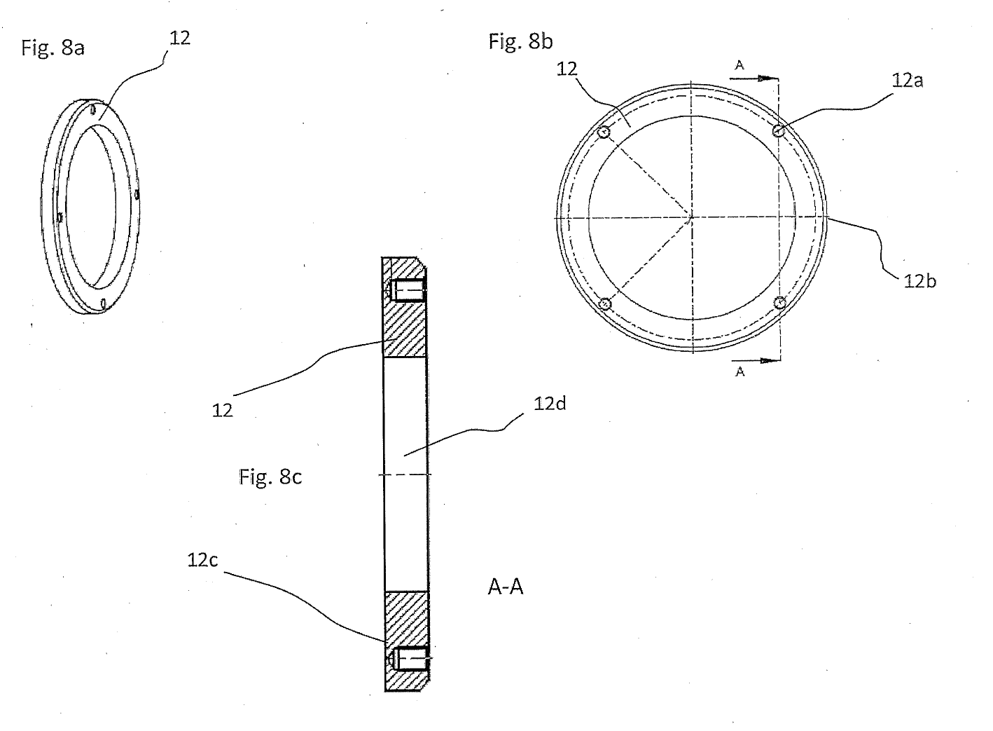

In order to improve the cutting operation, a cutting ring can be provided as the cutting plate. Such a cutting ring 12 is shown in FIGS. 8a, 8b and 8c. The cutting ring 12 preferably has four attachment bores 12a which are distributed at regular distances along the circumference and via which the cutting ring 12 is fixed in safe and simple fashion. For an easier installation of the cutting ring, the latter has a chamfer 12b on the outer side. Furthermore, the cutting ring has a supply opening 12d, through which the pressed material is conveyed. The pressed material to be cut is uniformly cut along the blade 12c extending along the circumference by cooperation of the cutting ring with the cutting press plunger 32. Another advantage of the cutting plate (or cutting ring) is that the latter can be exchanged, i.e. can be removed easily. Due to the exchange of the cutting plate, the quality of the cut can be adjusted. The cutting gap between cutting plate and cutting press plunger can be varied by exchanging the cutting plate. In particular, the cutting plate can be exchanged with a thicker or thinner cutting plate (or cutting ring), such that the cutting device can be adapted to the pressed material. The thickness of the cutting plate here refers to the axial extension, in the direction of the cutting press plunger. The rapid exchange is in particular also achieved by the screw connection of the cutting plate. Therefore, an exchange of the cutting plate is rendered possibly be loosening this screw connection.

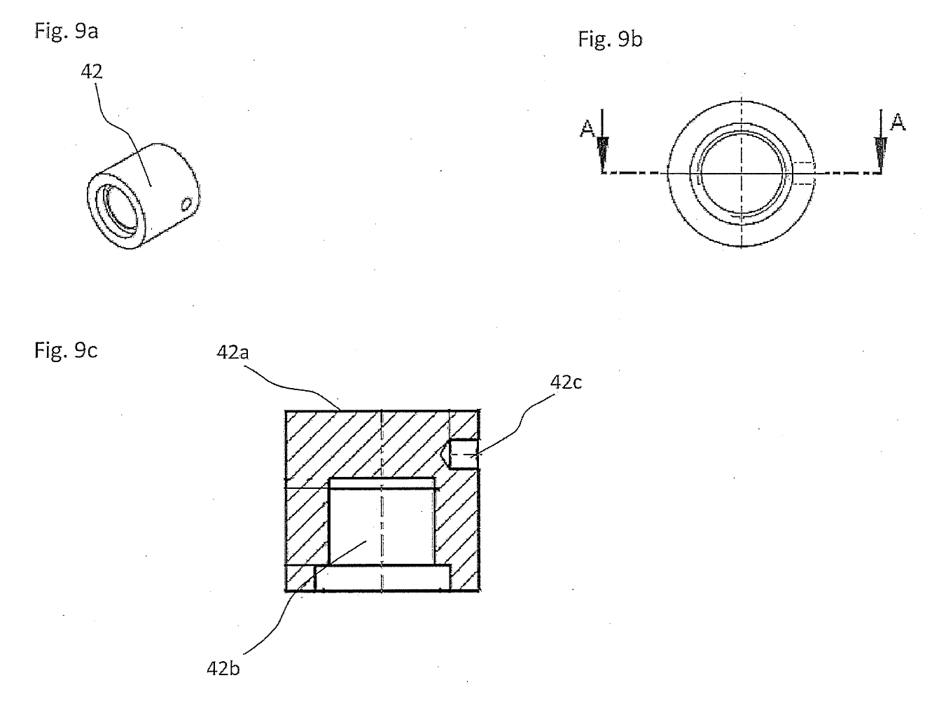

The main press plunger 42, which is connected to the main ram 41 via a connecting element 40, is shown in FIG. 9a. It has a connecting section which has an attachment support 42b. This attachment support 42b is mechanically connected to the main ram 41 via the connecting element 40 of the main press plunger 42. The attachment support 42b serves in particular for transmitting tensile forces while the compressive forces of the main press plunger 42 are transmitted via the planar connecting surfaces to the lower side of the main press plunger 42, which border directly on the main ram 41. The engagement surface 42a of the main press plunger is disposed on the upper side or the front side of the main press plunger 42. This engagement surface 42a acts directly on the pressed material in the main pressing chamber 4 in order to compact it. In order to optimize the pressing operation, the engagement surface 42a is has a cambered design on the front side of the main pressing plunger 42. FIG. 9c shows a sectional view A-A through the main press plunger 42. The course of section A-A is shown in FIG. 9b. Depending on the respective pressed material, the engagement surface 42a can be convex or concave or also conical. In addition, the main press plunger 42 has a lateral opening 42c.

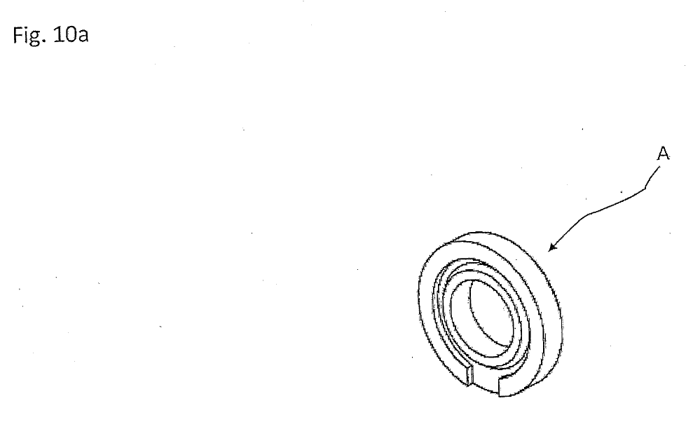

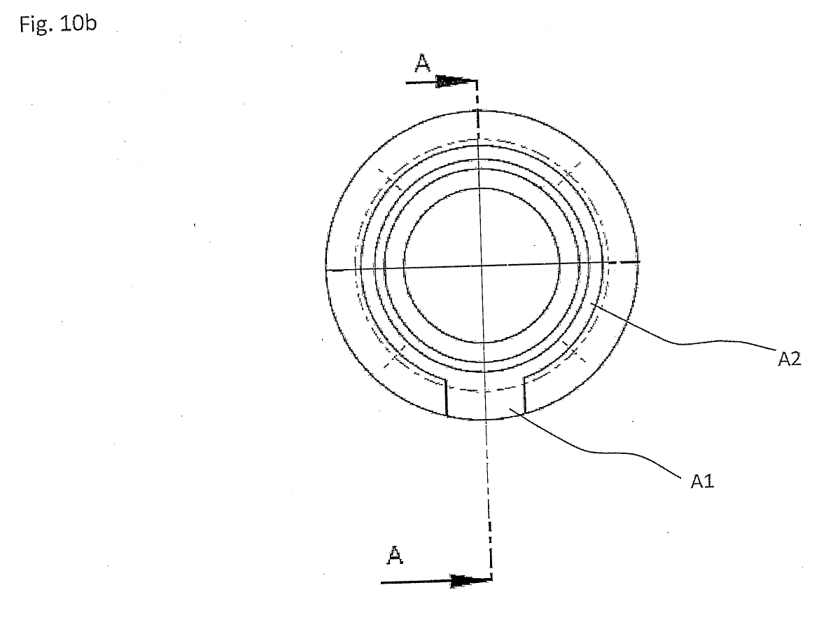

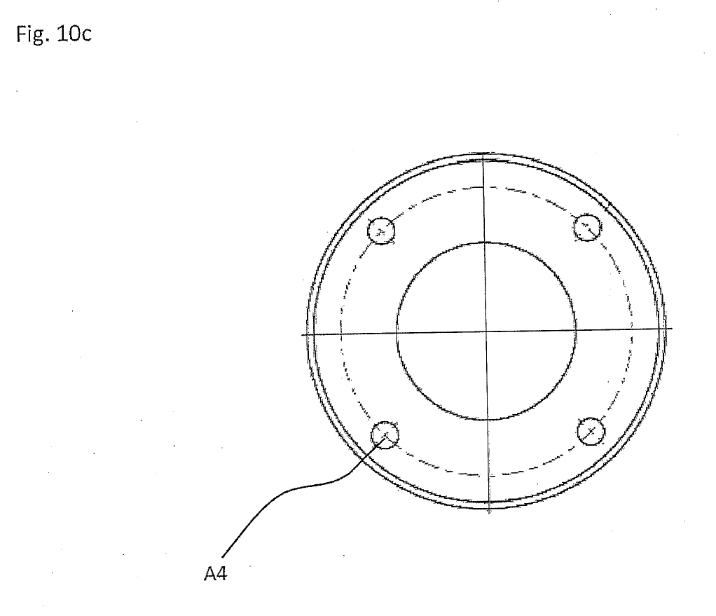

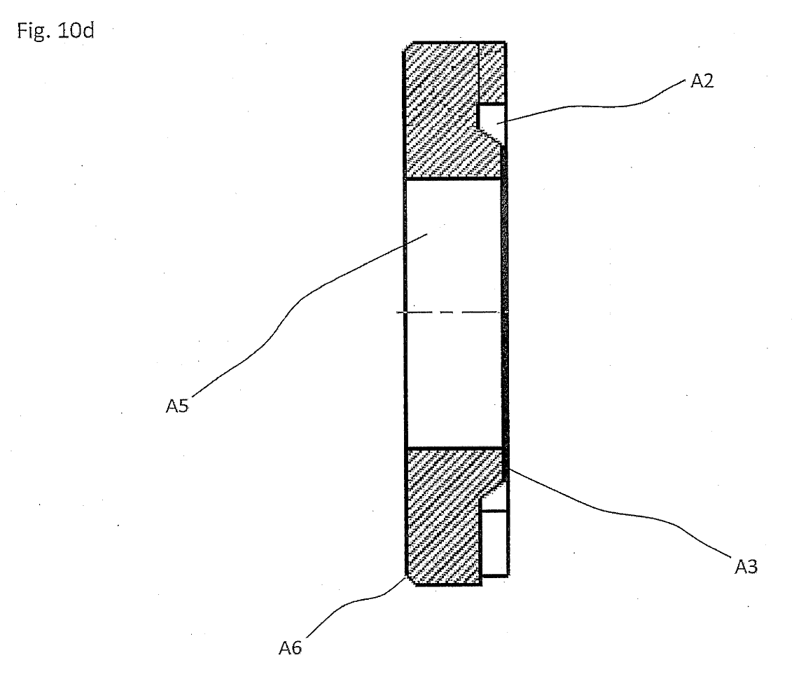

In order to remove the pressed-out liquid, an intermediate plate A, which is shown in FIG. 10a, can be provided in an embodiment. Alternatively or additionally, the pressed-out liquid can also be discharged directly via an opening in the main press pipe 43. The intermediate plate A has a discharge opening A1 and an annular receiving opening A2. The pressed-out liquid is received uniformly via the annular receiving opening A2 along the entire circumference in the end region of the press pipe 43 and is discharged via the discharge opening A1. In order to ensure the discharge of the pressed-out liquid, the intermediate plate A has a gap A3 between a through opening A5, which borders directly on the press pipe 43 and forms part of the main pressing chamber, said gap connecting the annular receiving opening A2 directly to the through opening A5 and thus to the main pressing chamber 4. The pressed-out liquid thus flows from the main pressing chamber via the gap A3 into the annular receiving opening A2 and further into the discharge opening A1 to finally reach the trough 5. The gap A3 is annular. The gap A3 preferably has a gap width of 0.1 mm to 3 mm and more preferably of 0.5 mm. In order to fit the intermediate plate A better into the central receiving part Z, the intermediate plate A has a chamfer A6. FIG. 10c shows the attachment bores A4, via which the intermediate plate A is mounted. Preferably these are four bores uniformly distributed over the circumference.

The cutting press plunger 32 is preferably made of metal and more preferably of a metal alloy which contains at least one of the materials chromium, vanadium or molybdenum.

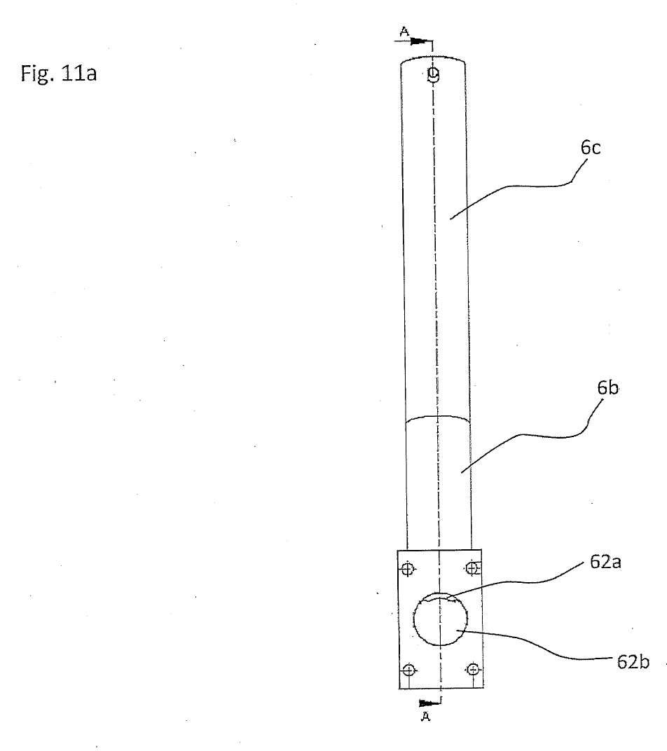

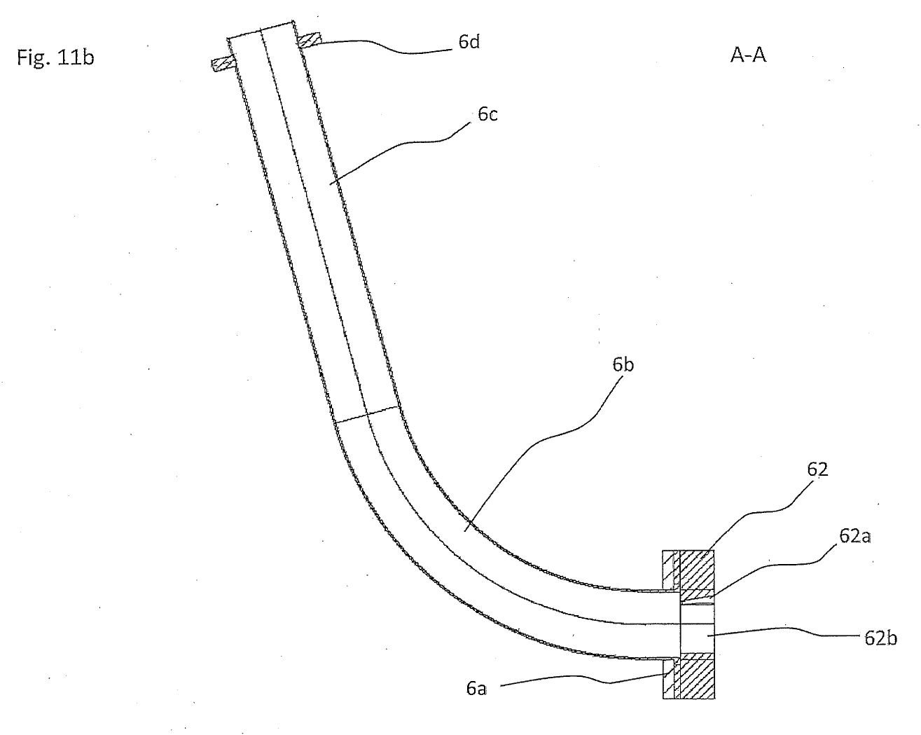

FIGS. 110 and 11b show an ejecting apparatus 6. The finished pellets are conveyed through an ejecting plate 62 which has a through opening 62b. The through opening here has an engagement part 62a, which tapers the through opening 62b in the ejecting direction. Thus, an influence can be exerted on the pellet once again during the ejecting operation and therefore this pellet can be compressed once again. The arch piece 6b is connected to the ejecting plate 62 via an attachment disk 6a. The tangent piece 6c of the ejector borders on the arch piece 6b and has a collar piece 6d in the end region.

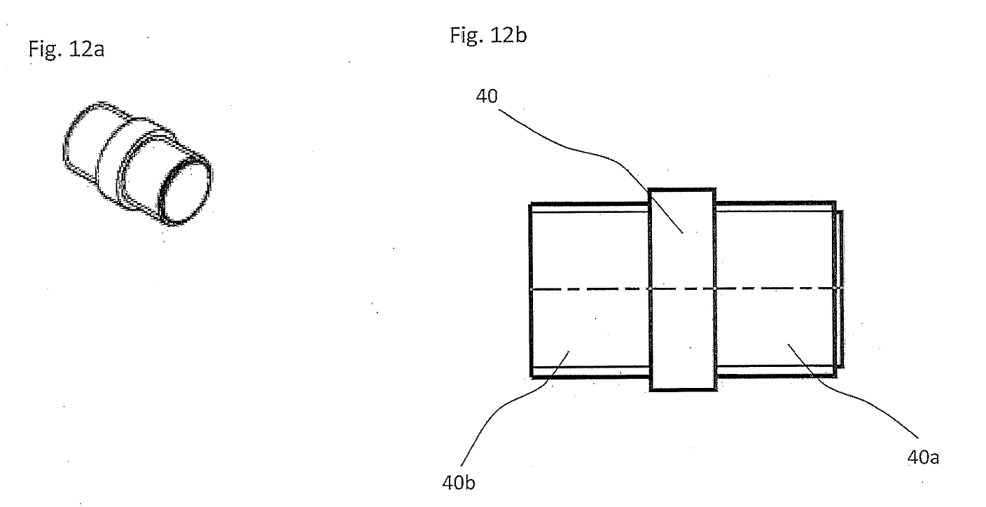

In order to elucidate the connection of the main press plunger 42 to the main ram 41 via the connecting element 40, it is shown once again in FIG. 12a. The connecting element 40 here has a first and a second threaded portion 40a, 40b, which is screwed into the main press plunger 42 and/or the main ram 41. The main press plunger 42 is screwed to the main ram 41 via the connecting element (threaded pin) 40.

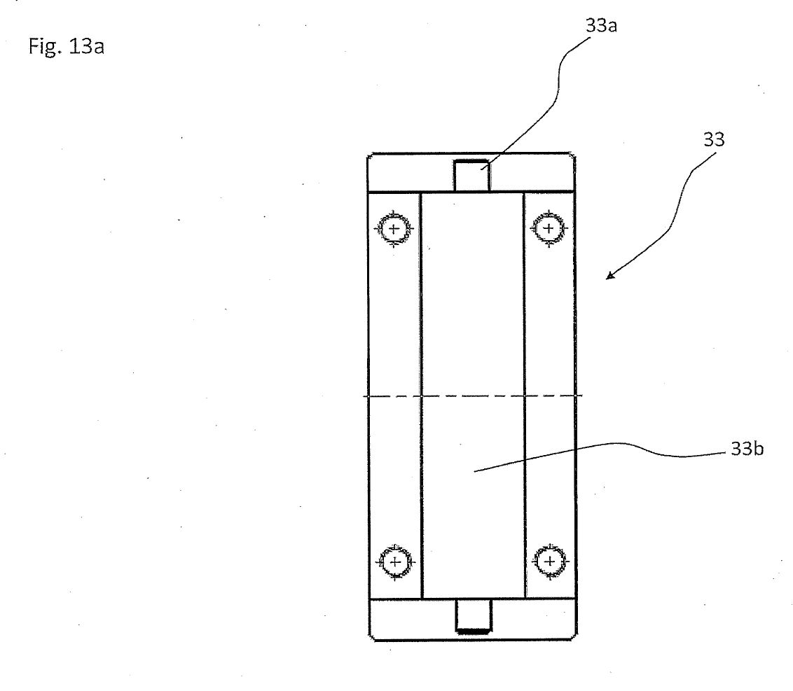

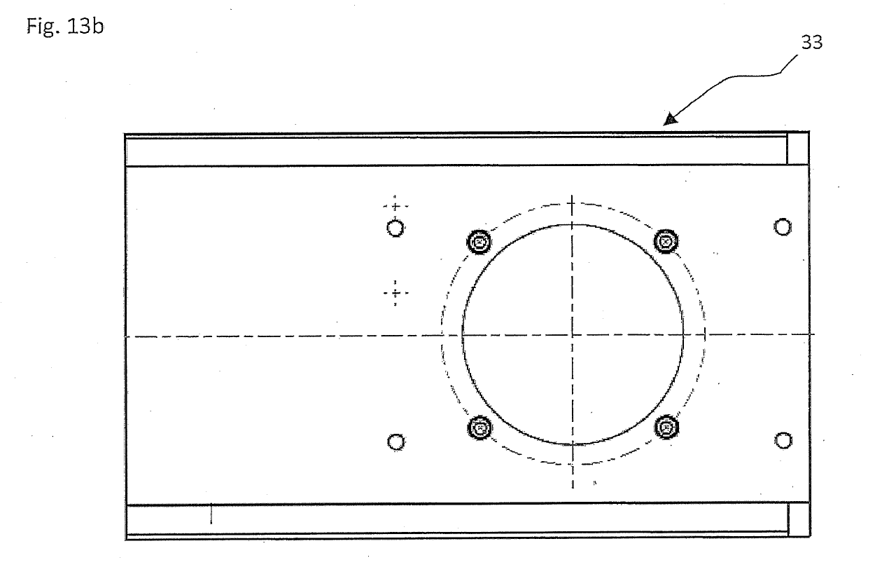

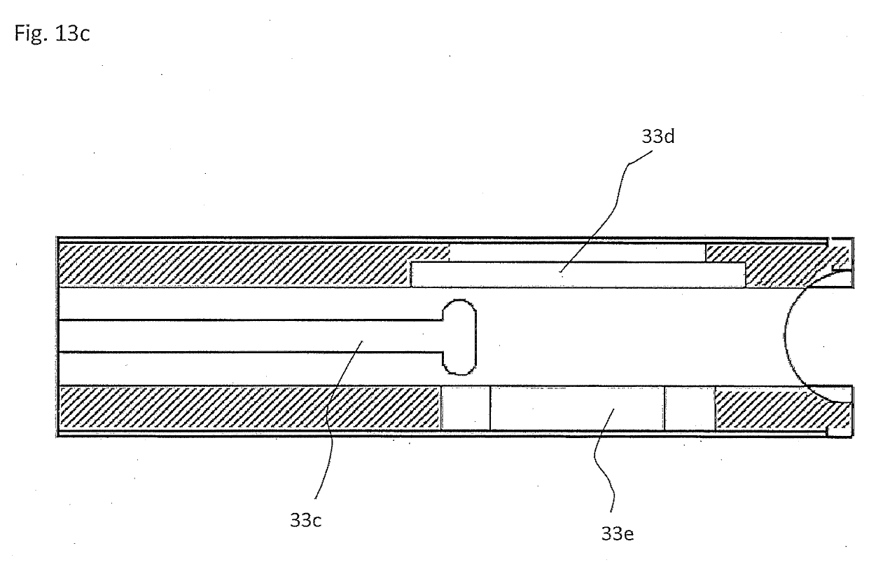

A guide for the cutting press plunger 32 is inserted into the central receiving part Z and preferably has hardened inner surfaces which are optimized for the sliding of the cutting press plunger 32. FIGS. 13a to 13c show the plunger guide 33. The plunger guide 33 has guiding surfaces which comprise in particular main guiding surfaces 33b. The base of the interior space of the plunger guide 33 is adapted to the base of the cutting press plunger 32 in such a way that, on the one hand, a movement of the cutting press plunger is rendered possible in the guide and, on the other hand, the clearance between the cutting press plunger and the inner guide surfaces is kept as small as possible to prevent jamming of the pressed material which would get between the guide surfaces. The cutting press plunger 32 is guided in the inner region of the plunger guide 33 on both sides in addition via lateral guide grooves 33c, with which the guide element 32c mesh, and limited as regards the movement thereof. The plunger guide 33 also has an opening 33e, which extends in the direction of the inspection over, and an opening for receiving the cutting ring, a cutting ring support 33d.

1. A device for producing pellets from pressed material, comprising
a feeding apparatus for receiving pressed material, which is arranged in the region of a feeder screw,
a pre-pressing chamber which can be fed by the feeder screw,
a closable main pressing chamber having a main ram movable in order to compact the content of the main pressing chamber, and
an ejecting apparatus for pellets, wherein
a cutting device for cutting the pressed material during or after entering the pre-pressing chamber, the device being designed to cut the pressed material supplied to the pre-pressing chamber via the feeder screw by means of the cutting device in such a way that cut pressed material is compacted in the pre-pressing chamber and/or main pressing chamber by the main ram.

2. The device according to claim 1, wherein the pre-pressing chamber can be fed via a supply section by the feeder screw, and the cutting device is arranged in the region of the supply section.

3. The device according to claim 1, wherein the cutting device comprises a cutting press plunger which has a cutting section and a pressing section in the end region so as to effect joint cutting and pressing of pressed material by moving the cutting press plunger in the region of the pre-pressing chamber.

4. The device according to claim 3, wherein the main pressing chamber can be closed by the cutting press plunger.

5. The device according to claim 3, wherein the cutting press plunger has a blade for cutting pressed material in the cutting section.

6. The device according to claim 3, wherein the cutting press plunger has a front face including a concave curvature.

7. The device according to claim 3, wherein the main pressing chamber is cylindrical and a concave part of the front face of the cutting press plunger forms part of the cylindrical lateral surface of the main pressing chamber for closing the main pressing chamber.

8. The device according to claim 7, wherein the cylindrical lateral surface of the main pressing chamber has a circular or elliptic base.

9. The device according to claim 3, wherein the main pressing chamber is made as a cavity of a pipe.

10. The device according to claim 1, wherein the device
has an intermediate plate in the region of the main pressing chamber, which includes a discharge opening for discharging liquid from the main pressing chamber, and
comprises a trough for receiving the liquid.

11. The device according to claim 10, wherein the discharge opening is made as an annular gap which borders on the main pressing chamber.

12. The device according to claim 1, wherein the main pressing chamber has a discharge opening for discharging the liquid pressed-out from the pressed material.

13. The device according to claim 1, wherein a cutting plate having a cutting edge is arranged in the supply section, the cutting plate being formed as a cutting ring.

14. The device according to claim 13, wherein the cutting press plunger is arranged so as to be translationally movable in such a way that cutting of pressed material can be achieved by moving the cutting press plunger with the blade in relation to the cutting plate.

15. The device according to claim 1, wherein the ejecting apparatus has a closing slide an intermediate piece having an opening and the opening is arranged in such a way that compacted pressed material can be moved through the opening, the opening having a funnel-shaped design.

16. The device according to claim 1, wherein the main ram has a main press plunger which has a cambered front face.

17. The device according to claim 1, Wherein for discharging liquid into a container, the trough has a funnel-shaped inclined bottom.

18. A machine tool having a device according to claim 1.

19. The machine tool according to claim 16, wherein the liquid pressed out of the pressed material is returned to the machine tool via the device.
